(19) United States
(12) Patent Application Publication
(10) Pub. No.: US 2003/0167330 A1
(43) Pub. Date: Sep. 4, 2003

(54) Continual rebinding of data sources

(76) Inventors: Norman H. Cohen, Suffern, NY (US); Apratim Purakayastha, Yorktown Heights, NY (US); Luke Wong, Norwood, NJ (US); Danny L. Yeh, Mt. Vernon, NY (US)

Correspondence Address: Ido Tuchman, 69-60 108th Street, Suite 503, Forest Hills, NY, 11375, US

(21) Appl. No.: 10/087,647

(22) Filed: Mar. 1, 2002

(51) Int. Cl. G06F 15/173

(52) U.S. Cl. 709/226

(57) ABSTRACT

A method, system and computer program for rebinding a binding expression to an appropriate network resource in response to changes in the requirements placed upon the resources or in response to changes in the properties of the currently bound network resource. The binding expression includes a data specification describing the properties required for the resource. Rebinding entails obtaining a list of potential appropriate network resources, selecting an appropriate network resource from the list, and rebinding the binding expression to that resource.

### FIELD OF THE INVENTION

The present invention relates generally to gathering data from data sources on a computer network, and more specifically to rebinding a binding expression to an appropriate data source in accordance with a particular data specification.

### BACKGROUND

There are many well-known techniques for recording fixed correspondences between local computational entities and resources on a computer network. For example, U.S. Pat. No. 5,873,093 describes a method and apparatus for maintaining a correspondence between network data sources and object classes capable of representing the data from those sources. However, the properties of resources on a network often change, creating a need to update the correspondence accordingly.

A number of systems maintain a dynamic correspondence between local computational entities and network resources. One approach, exemplified by U.S. Pat. Nos. 5,708,772 and 6,269,400, is to expect communication from the network resources at regular intervals, and to update the correspondence to indicate that a resource is unavailable if no communication is received after the specified interval. U.S. Pat. No. 5,668,952 extends this approach, initiating a search for a movable resource elsewhere in the network when it stops responding from its previously known location.

Each of the approaches heretofore mentioned provides for the discovery of a unique network resource corresponding to a local computational entity. However, many applications require discovery not of the resource associated with a particular computation entity, but of any resource meeting certain criteria. U.S. Pat. No. 6,151,624 provides for the discovery of network resources, such as web pages, tagged with metadata, whose metadata match a description in any of several possible natural languages. U.S. Pat. No. 6,269,400 (cited earlier) provides for the discovery of network addresses, selected from a specified superset, at which specified services can be found. U.S. Pat. No. 6,101,537 associates location-independent, path-independent names to movable network resources, and provides for the discovery of such a resource at its current location. U.S. Pat. Nos. 5,408,619 and 5,668,952 describe similar capabilities to bind abstract specifications to resources; the latter patent does so using the timeout-interval approach described earlier. U.S. Pat. No, 5,909,549 augments the timeout approach with automated re-registration of a network resource once it can reestablish communications.

These approaches maintain an up-to-date correspondence of keys, such as abstract names or other computational entities, with network resources, allowing a key to be bound to the resource that is most appropriate at the time of the binding. However, once the binding is established, it remains fixed, even if subsequent changes in network resources change the correspondence on which the binding was based. Thus, the changes in the updated correspondence affect only bindings that will be made in the future, not bindings that have already been made. The method described in U.S. Pat. No. 5,793,977 does not maintain a current correspondence, but initiates communication among network nodes if necessary to discover a resource to be bound. This approach shares the same deficiency, namely that the binding, once made, remains fixed, even if the network conditions upon which the binding was based are modified.

In summary, current approaches for establishing a binding to the currently most appropriate network resource suffer from serious deficiencies. A binding, once made, is not modified when a different binding would be more appropriate. In systems that discover a binding to the most appropriate resource satisfying an abstract specification, a current binding can become inappropriate because the abstract specification changes. In any system whose bound resources have changing properties, a change in properties of the currently bound resource may render that resource inappropriate. In either case, the user of the binding is left with the responsibility for determining when the current binding has become inappropriate, and initiating rebinding.

### SUMMARY OF THE INVENTION

The present invention addresses the above-identified problems with the prior art by providing a method, system and computer program product for rebinding a binding expression to an appropriate resource in a network.

Thus, one aspect of the invention is a system for rebinding a binding expression to a new network resource, wherein a data specification describes a resource required by the binding expression. The system includes a data resolution service configured to discover network resources that satisfy the data specification. A means for rebinding rebinds the binding expression to the new network resource when the data specification changes.

Another aspect of the invention is a system for rebinding a binding expression to a new network resource, wherein a data specification describes a resource required by the binding expression and a resource descriptor describes a currently bound network resource. The system includes a data resolution service configured to discover network resources that satisfy the data specification. A means for rebinding rebinds the binding expression to the new network resource when the resource descriptor changes.

Another aspect of the invention is a method for rebinding a binding expression to an appropriate network resource in a network. The binding expression is associated with a data specification describing the data required at the binding expression. The network includes a current network resource, and the network resources include at least one resource property. The method comprises an obtaining operation to obtain a list indicating potential appropriate network resources. A selecting operation selects an appropriate network resource from the list. A rebinding operation rebinds the binding expression to the appropriate network resource.

Another aspect of the invention is a system for rebinding a binding expression to an appropriate network resource in a network. The binding expression is associated with a data specification describing the data required at the binding expression. The network includes a current network resource, and the network resources include at least one resource property. The system includes a data resolution service configured to provide a list indicating potential appropriate network resources. A port manager is configured to provide an access port to an appropriate network resource such that the binding expression rebinds to the appropriate network resource via the access port.

Yet another aspect of the invention is a computer program product embodied in a tangible media. The computer program includes computer readable program codes for rebinding a binding expression to an appropriate network resource in a network, with the binding expression being associated with a data specification describing the data required at the binding expression. The network includes a current network resource, and the network resources include at least one resource property. The computer readable program codes include a first computer readable program code configured to cause the program to provide a list indicating potential appropriate network resources. A second computer readable program code is configured to cause the program to select an appropriate network resource from the list. A third computer readable program code is configured to cause the program to rebind the binding expression to the appropriate network resource.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows an exemplary computer network environment embodying the present invention.

FIGS. 2A and 2B show a flow chart of an exemplary specification-driven rebinding algorithm in accordance with the present invention.

FIG. 3 shows an exemplary system employing an exemplary specification-driven rebinding process contemplated by the present invention.

FIGS. 4A and 4B show a flow chart of an exemplary advertisement-driven rebinding algorithm in accordance with the present invention.

FIG. 5 shows an exemplary system employing an exemplary advertisement-driven rebinding process contemplated by the present invention.

### DETAILED DESCRIPTION OF THE INVENTION

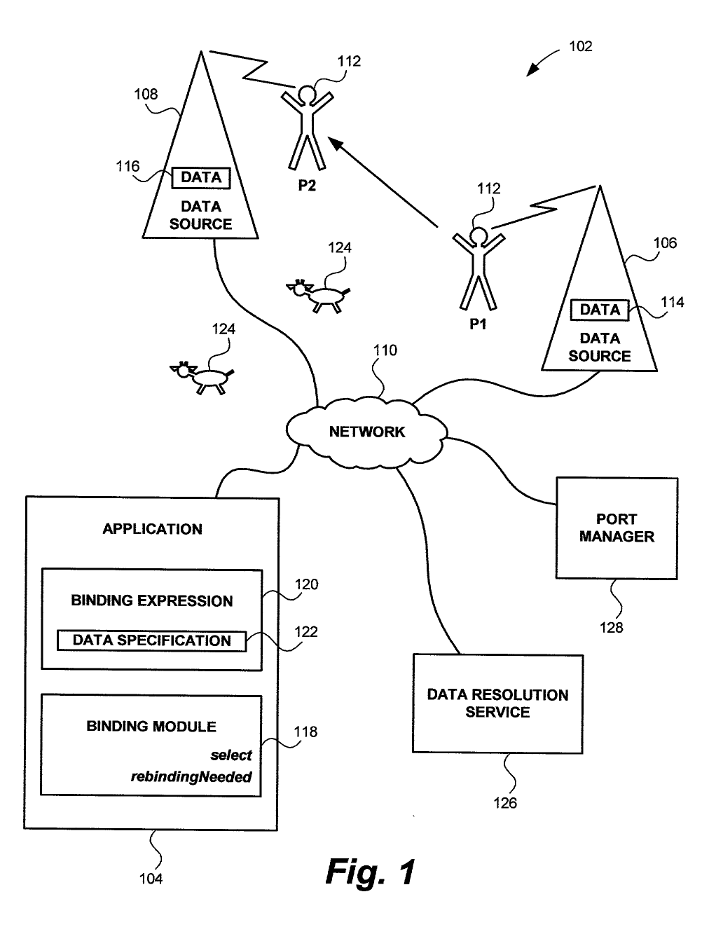

In general, the present invention is a mechanism for applications using network resources to rebind to an appropriate resource as resource characteristics and data specifications change. The invention is described in detail below with reference to FIGS. 1-5. When referring to the figures, like structures and elements shown throughout are indicated with like reference numerals.

In FIG. 1, an exemplary environment 102 embodying the present invention is shown. The environment 102 includes a computer application 104 which communicates with network resources, such as data sources 106 and 108, through a computer network 110. It is contemplated that the computer network 110 may be any type of network known in the art. In particular, the network 110 may include a public network, such as the Internet.

The application 104 utilizes data from various network resources, such as data sources 106 and 108, to perform one or more tasks or computations. For example, the application 104 may monitor the physical location of a person 112 as he or she moves about. Thus, the data 114 and 116 received by the application 104 from the data sources 106 and 108 may be the person's current position. Furthermore, data source 106 may be a sensor configured to provide the person's position in one region and data source 108 may be a sensor configured to provide the person's position in another region. As the person 112 moves about the area, the application 104 may sometimes require data 114 from data source 106, and other times require data 116 from data source 108.

The application 104 includes a binding module 118 which provides the application 104 the required data from the data sources 106 and 108. It is contemplated that the application 104, including the binding module 118, may be specific to the computer environment and task at hand, and may therefore be provided by a programmer. Within the application 104 is a binding expression 120 configured to contain data from one of the data sources 106 and 108. In other words, the binding expression 120 acts as a placeholder for data from a current data source of interest. The binding expression 120 contains a data specification 122 calling for, for example, a data source capable of providing the position of person 122.

In order for the binding expression 120 to provide data from a particular data source, it must be bound to the data source. While a binding expression 120 is bound to a given data source, all requests for the current value of the binding expression 120 are satisfied by obtaining a value from that data source, and each new value generated by the data source is reported as a new value generated by the binding expression 120. Thus, returning to the example above, when the person 112 is at position P1, the binding express 120 is bound to data source 106 and receives data 114 from data source 106. If, at a later time, the person 112 moves to position P2, the binding expression 102 is rebound to data source 108 and receives data 116 from data source 108.

A data specification 122 describes the data required by the binding expression 102. It is contemplated that the data specification may change over time. For example, the application 104 may cease monitoring the position of the person 112 and begin monitoring the position of, say, a goat 124. If this occurs, the data specification 122 or a sub-expression of the data specification 122 is modified such that the data specification 122 now calls for a data source capable of providing the position of the goat 124 rather than the position of the person 112. The binding expression 120 is then rebound to a data source monitoring the goat's position, if such a data source exists.

The environment 102 further includes a data resolution service 126. The data resolution service 126 is configured to receive a data specification 122, for example from binding module 118 and return a list of data sources, such as data sources 106 and 108, that are capable of providing the data called for in the data specification 122. Furthermore, the data resolution service 126 is configured to receive advertisements from data sources such as data sources 106 and 108. Data source advertisements can describe properties of the data provided by data sources 106 and 108, properties of the data sources 106 and 108 themselves, or a combination thereof. Typically, when a data source property changes, the data source 106 or 108 submits a new advertisement to the data resolution service 126, overriding any previous advertisement stored by the data resolution service 126. The data resolution service 126 may additionally provide an update notification to the binding module 118 when a change in a property of the currently bound data source 106 or 108 is received.

A port manager 128 in the environment 102 is configured to provide access ports to data sources, such as data sources 106 and 108 in the network 110. As contemplated by the present invention, an access port is any data channel permitting access to data such as data 114 and 116 provided by a data source such as data source 106 and 108. For example, an access port may be a file handle, a socket, or a subscription to a message service. In one embodiment of the invention, when a data source descriptor is input to the port manager 128, the port manager 128 outputs an access port to the data source described by the data source descriptor.

As mentioned above, the present invention is a mechanism for applications 104 using data sources to rebind a binding expression 120 to the appropriate data source 106 and 108 as data source characteristics and data specifications change. When rebinding is necessitated because of a change in data source characteristics, the rebinding process is referred to herein as advertisement-driven rebinding. For example, if an application 104 tracking the location of a person 112 using network data source 106 receives a notification from the data resolution service 126 that the current data source 106 can no longer report on the subject's position, an advertisement-driven rebinding process (for example, to data source 108) would occur. On the other hand, when rebinding is necessitated because of a change in the data specification, the rebinding process is referred to herein as specification-driven rebinding. For example, if an application 104 tracking the location of a person 112 using network data source 106 or 108 changes the data specification 122 of the binding expression 120 from the position of the person 112 to a position of the goat 124, a specification-driven rebinding process would occur.

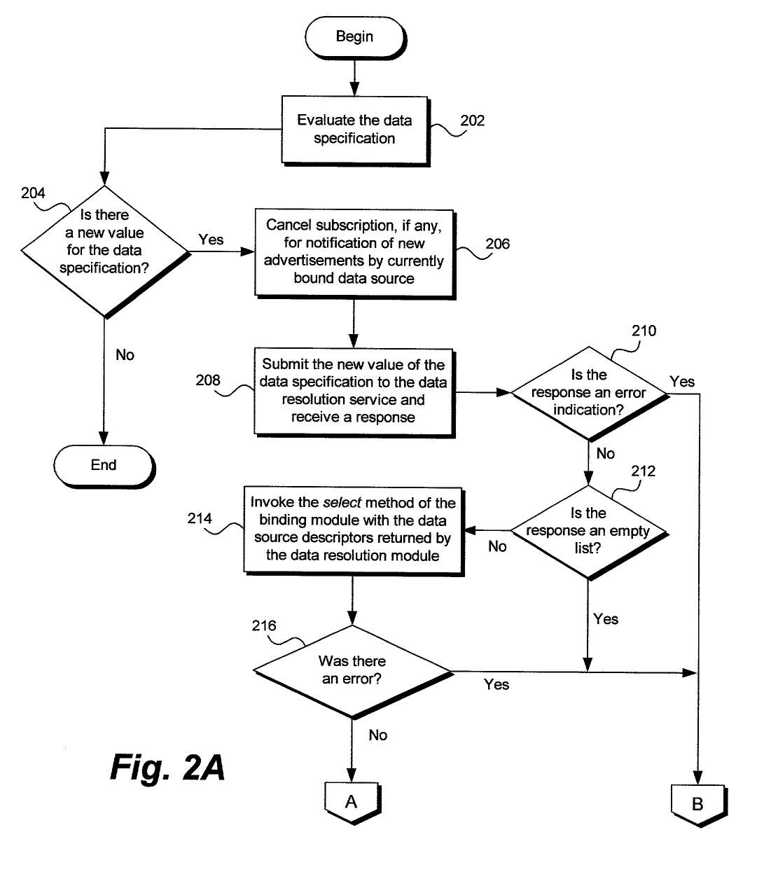

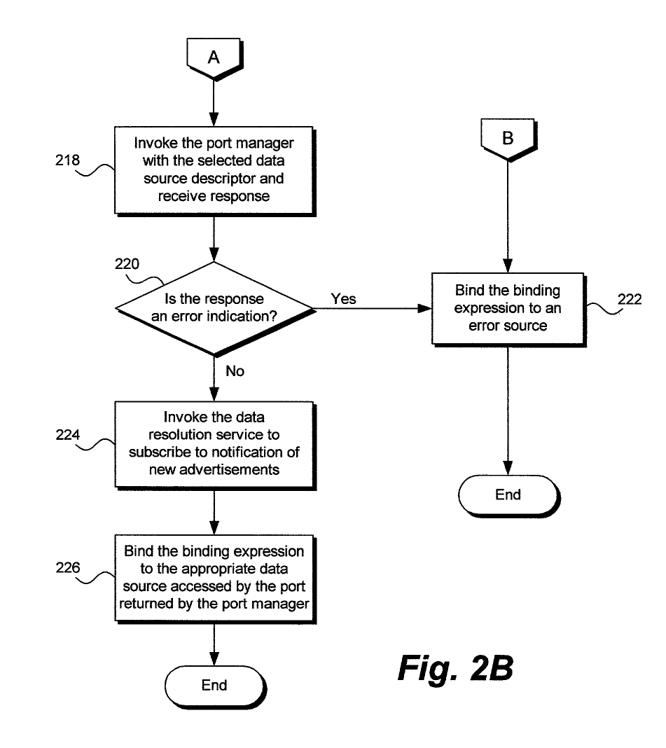

In FIGS. 2A and 2B, a flow chart of an exemplary specification-driven rebinding algorithm contemplated by the present invention is shown. The logical operations of the algorithm may be implemented (1) as a sequence of computer implemented steps running on a computer system and/or (2) as interconnected machine modules within the computing system. The implementation is a matter of choice dependent on the performance requirements of the system applying the invention. Accordingly, the logical operations making up the embodiments of the present invention described herein are referred to alternatively as operations, steps, or modules.

At evaluating operation 202, the data specification is evaluated. Although it is contemplated that the data specification may be evaluated at any time, in general, the data specification is evaluated under the following circumstances: when the computation containing the data specification is initialized; when a request is received for the current value of the data specification; and when notification is received that one of the sub-expressions of the data specification has obtained a new value. After the data specification is evaluated, control passes to comparing operation 204.

At comparing operation 204, the new value of the data specification is compared to the previous value, if any, of the data specification. If the two values are equal, then the current data source is still the appropriate data source bound to the binding expression and the algorithm ends. If, however, the data specification yields a new value, or if the data specification has not been evaluated previously, control passes to canceling operation 206.

At canceling operation 206, a subscription for update notifications of the current data source, if such a subscription exists, is canceled. An update notification, as mentioned above, alerts the binding module when a change in property of the currently bound data source occurs. Since the currently bound data source is being unbound, the notification subscription is canceled. Once the canceling operation is completed, control passes to submitting operation 208.

At submitting operation 208, the binding module submits the new data specification value to the data resolution service. The new data specification value acts as a request for a list of potential appropriate data sources configured to supply the data described by the data specification. The data resolution service, in turn, sends a response to the binding module. After the binding module receives the response from the data resolution service, control passes to checking operations 210 and 212.

At checking operations 210 and 212, the response returned by the data resolution service is examined to determine if there is at least one data source listed. If the response is an error indication, then, at checking operation 210, control passes to binding operation 222 (see FIG. 2B) where the binding expression is bound to an error source. Likewise, if the response is an empty list of data sources, then, at checking operation 212, control again passes to binding operation 222. If the response is a list containing at least one data source, then control passes to invoking operation 214.

At invoking operation 214, the binding module chooses one of the data sources found on the data source list. It is contemplated that the logic and/or computation required to determine which data source is appropriate is application-specific and will be provided by a programmer. In one embodiment of the invention, a select method is called by the binding module to pick one of the data sources listed in the data source list. Once invoking operation 214 is completed, control passes to checking operation 216.

At checking operation 216, a determination of whether an error occurred during invoking operation 214 is made. The select method, for example, may have produced an exception or may have returned an out-of-range result. If such an event occurs, control passes to binding operation 222 (see FIG. 2B) where the binding expression is bound to an error source. If, however, no error is reported in checking operation 216, control passes to invoking operation 218 (see FIG. 2B).

At invoking operation 218, the binding module invokes the port manager by sending an indication of the data source selected to be the bound data source. The port manager, in response, provides an access port to the selected data source. As mentioned above, the access port may be a file handle, a socket, etc. After the binding module receives a response from the port manager, control flow passes to checking operation 220.

In checking operation 220, the response from the port manager is analyzed to determine if an error indication, rather than an access port, was sent. If the response was an error indication, control passes to binding operation 222, where the binding expression is bound to an error source. If the response was a valid access port, control passes to subscribing operation 224.

At subscribing operation 224, the binding module invokes the data resolution service by subscribing to notifications of new advertisements from the newly selected data source. Thus, when the new data source informs the data resolution service that a change in its property has occurred, the data resolution service will forward the change to the binding module. After subscribing operation 224 is completed, control passes to binding operation 226.

At binding operation 226, the binding module binds the binding expression to the port obtained in invoking operation 218.

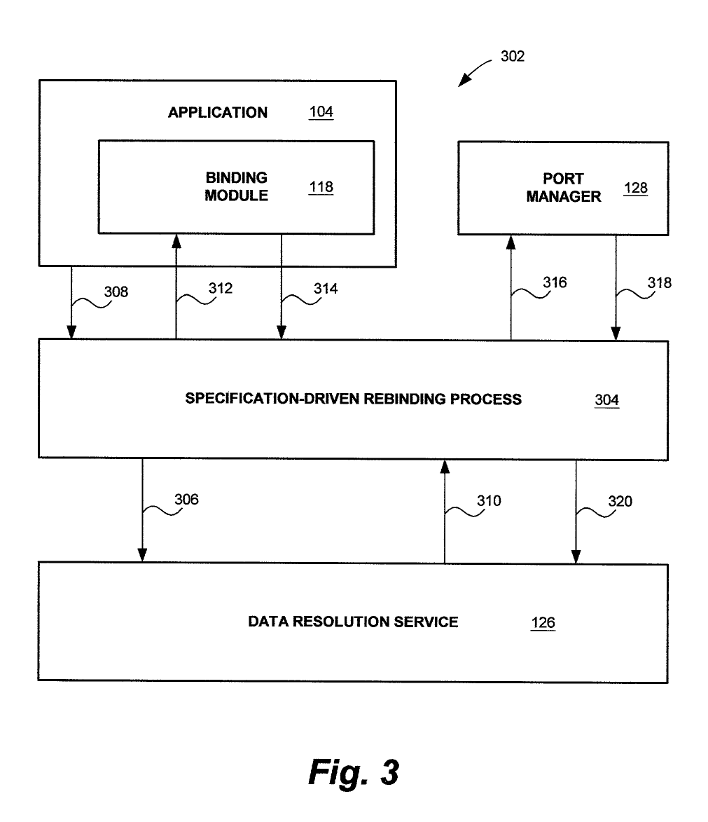

In FIG. 3, an exemplary system 302 employing a specification-driven rebinding process 304 contemplated by the present invention is shown. In accordance with the present invention, the specification-driven rebinding process 304 can be a computer readable program embodied as computer readable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the hand-off controller. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As discussed above, specification-driven rebinding typically begins when an evaluation of the data specification yields a new value, or when the data specification has not been previously evaluated. If such a condition exists, the system 302 initiates the specification-driven rebinding process 304 by sending a cancel notification command 306 to the data resolution service 126. After the cancel notification 306 is sent, the new value of the data specification 308, obtained from the application 104, is submitted to the data resolution service 126.

If data sources offering the type of data called for in the data specification exist on the network, the data resolution service 126 responds by providing a list 310 of one or more potential appropriate data sources. At least one descriptor for each data source is included on the list 310. The rebinding process 304 then forwards the list 312 to the binding module 118 of the application 104 so that an appropriate data source can be selected from the list 312. In one embodiment of the invention, the list is a data-source-descriptor array, and the binding module 118 indicates the appropriate data source in the form of an index into this array. A select method in the binding module 118 may be used to determine the appropriate data source.

An indication 314 of the selected data source descriptor from the list 312 is returned by the binding module 118. The rebinding process 304 then transmits the selected data source descriptor 316 to the port manager 128. As discussed above, the port manager 128 provides an access port 318 to the selected data source based on the data source descriptor 316. The binding expression then rebinds to the appropriate data source using the access port 318. In addition, a subscription 320 is sent to the data resolution service 126 to provide update notifications of new advertisements from the selected appropriate data source to the binding module 118.

As mentioned above, certain departures from the normal specification-driven rebinding process 304 may occur. These departures are triggered by the following events:

1. The data resolution service 126 may respond with an error indication rather than with a set of data source descriptors 310.

2. The data resolution service 126 may respond with an empty set of data source descriptors.

3. The select method of the binding module 118 may throw an exception.

4. The select method of the binding module 118 may return an out-of-range array index.

5. The port manager 128 may respond with an error indication rather than with an access port 318.

In any of these situations, no subscription is made to notifications of new advertisements, and the binding expression is bound to an error source. As used herein, an error source is a source that returns a special error value whenever it is asked for its current value.

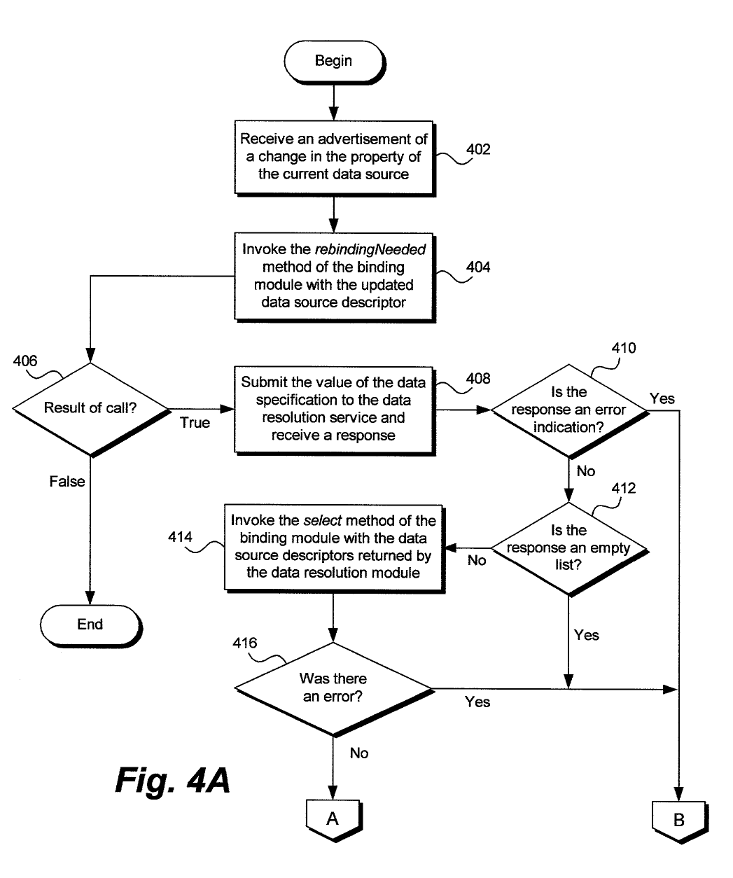

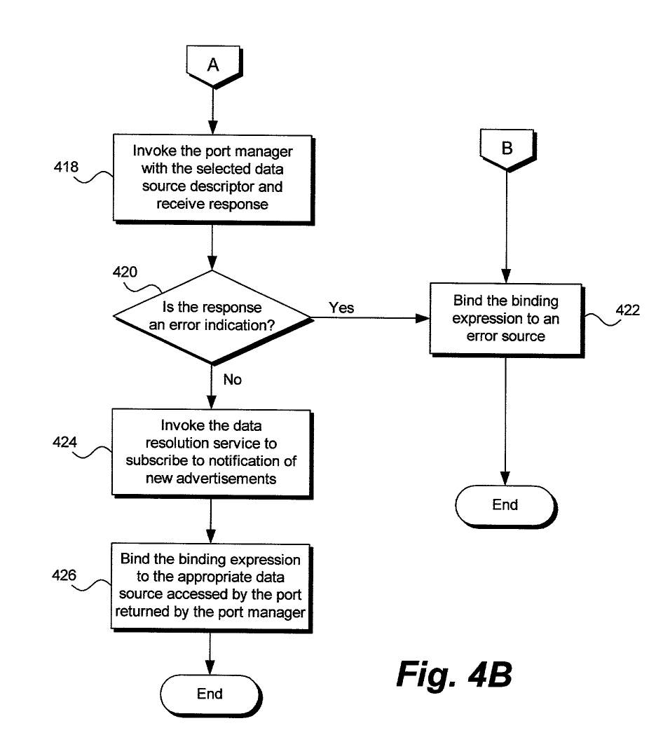

In FIGS. 4A and 4B, a flow chart of an exemplary advertisement-driven rebinding algorithm contemplated by the present invention is shown. The logical operations of the algorithm may be implemented (1) as a sequence of computer implemented steps running on a computer system and/or (2) as interconnected machine modules within the computing system.

At receiving operation 402, the data resolution service receives an advertisement from the current data source that a change in a data-source property has occurred. As described above, a data-source property includes a property about the data source itself or about the data it is providing. Examples of such properties are the timeliness of the data and the location of a mobile data source. Once the advertisement is received at operation 402, control passes to invoking operation 404.

At invoking operation 404, the data resolution service invokes the binding module with an update notification. The update notification is designed to inform the binding module that a change in the currently bound data source has occurred. In a particular embodiment of the invention, the update notification includes an update descriptor indicating the data source property changed in the current data source. A method in the binding module, say rebindingNeeded, determines if the change in data source property requires the binding expression be rebound to another data source. Once invoking operation 404 is completed, control passes to checking operation 406.

At checking operation 406, the result from the rebindingNeeded method is checked. If the change in property of the current data source does not require the binding expression be rebound to another data source, the advertisement-driven rebinding algorithm is ended. If, however, the change in property of the current data source requires the binding expression be rebound to another data source, control passes to submitting operation 408.

At submitting operation 408, the current value of the data specification is submitted to the data resolution service. The data specification value acts as a request for a list of potential appropriate data sources capable of supplying the data called for by the data specification. The data resolution service, in turn, sends a response to the binding module. After the binding module receives the response from the data resolution service, control passes to checking operations 410 and 412.

At checking operations 410 and 412, the response returned by the data resolution service is examined to determine if there is at least one data source listed. If the response is an error indication, then, at checking operation 410, control passes to binding operation 422 (see FIG. 4B) where the bind expression is bound to an error source. Likewise, if the response is an empty list of data source, then, at checking operation 412, control again passes to binding operation 422. If the response is a list containing at least one data source, then control passes to invoking operation 414.

At invoking operation 414, the binding module chooses one of the data sources found on the data source list. As stated earlier, a select method may be called by the binding module to pick one of the data sources listed in the data source list. Once invoking operation 414 is completed, control passes to checking operation 416.

At checking operation 416, a determination of whether an error occurred during invoking operation 414 is made. The select method, for example, may have produced an exception or may have returned an out-of-range index. If such an event occurs, control passes to binding operation 422 (see FIG. 4B) where the bind expression is bound to an error source. If, however, no error is reported in checking operation 416, control passes to invoking operation 418 (see FIG. 4B).

At invoking operation 418, the binding module invokes the port manager by sending an indication of which data source in the data source list is selected to be the bound data source. The port manager, in response, provides an access port to the selected data source, based on the data source indication. After the binding module receives a response from the port manager, control flow passes to checking operation 420.

In checking operation 420, the response from the port manager is analyzed to determine if an error indication, rather than an access port, was sent. If the response was an error indication, control passes to binding operation 422 where the bind expression is bound to an error source. If the response was a valid access port, control passes to subscribing operation 424.

At subscribing operation 424, the binding module invokes the data resolution service by subscribing to notifications of property changes to the newly selected appropriate data source. Additionally, if the appropriate data source is different than the previously bound data source, any subscriptions for notification relating to the previously bound data source are canceled. Thus, when the new data source informs the data resolution service that a change in its property has occurred, the data resolution service will forward the change to the binding module. After subscribing operation 424 is completed, control passes to binding operation 426.

At binding operation 426, the binding module binds the binding expression to the access port for the data source selected from the data source list. The binding module uses the access port provided by the port manager to access the data at this data source. Once binding operation 426 is completed, the advertisement-driven rebinding algorithm is ended.

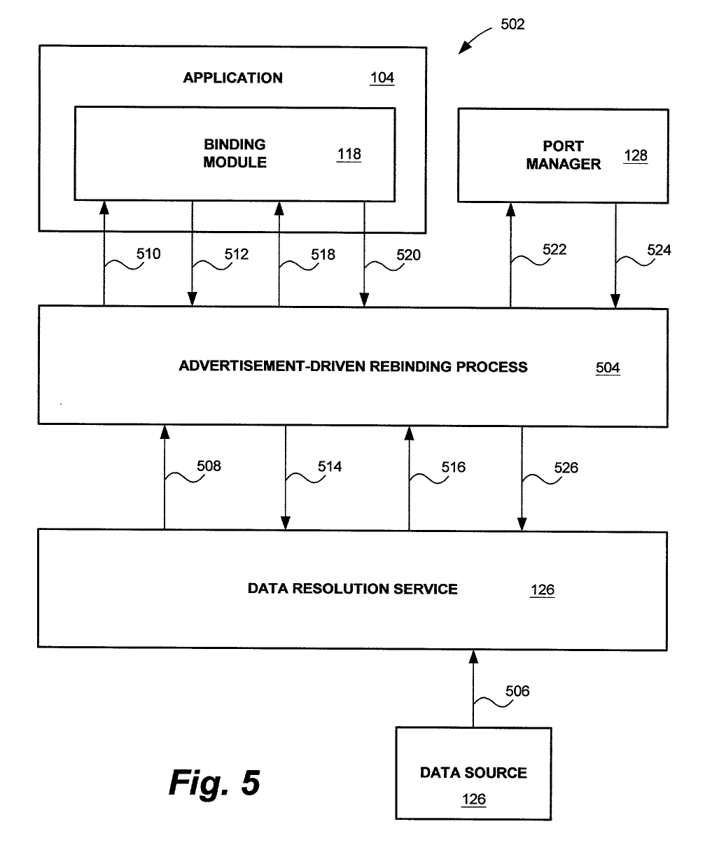

In FIG. 5, an exemplary system 502 employing an advertisement-driven rebinding process 504 is shown. It is contemplated that the advertisement-driven rebinding process 504 can be a computer readable program embodied as computer readable media.

The advertisement-driven rebinding process 504 is triggered when a new advertisement 506 from the currently bound data source is received by the data resolution service 126. As mentioned above, a data source advertisement describes a change in at least one data source property. The data resolution service 126, in accordance with a subscription for data source notifications, responds by sending an update notification 508 to the advertisement-driven rebinding process 504. It is contemplated that the update notification 508 includes an update descriptor 510 indicating the change in the data source property of the current data source.

The advertisement-driven rebinding process 504 invokes the rebindingNeeded method of binding module 118, passing update descriptor 510 as a parameter. If the result 512 is true, indicating that rebinding is required, the binding module 118 submits the current data specification 514 to the data resolution service 126. The data resolution service 126, in turn, responds with a list 516 of one or more potential appropriate data sources. At least one descriptor for each data source is included in the list 516. The rebinding process 504 then forwards the list 518 to the binding module 118 so that an appropriate data source can be selected.

A select method in the binding module 118 can be used to select an appropriate data source from the list 518. The method returns an indication 520 of the selected data-source descriptor to the advertisement-driven rebinding process 504. The rebinding process 504 transmits the selected data source descriptor 522 to the port manager 128. In response, the port manager 128 returns an access port 524 to the appropriate data source based on the transmitted data-source descriptor 522.

At this point, if the access port 524 to the appropriate data source is different from the currently bound data source, the data resolution service 126 is invoked 526 to cancel any subscription for notifications of new advertisements by the currently bound data source, and to subscribe to notifications of new advertisements by the newly selected appropriate data source. Finally, the binding module 118 rebinds the binding expression to the appropriate data source via the access port 524.

As was the case with the specification-driven rebinding process, certain departures from the normal advertisement-driven rebinding process 504 may occur. These departures are triggered by the following events:

1. The rebindingNeeded method of the binding module 118 may throw an exception.

2. The data resolution service 126 may respond with an error indication rather than with a list of data source descriptors 516.

3. The data resolution service 126 may respond with an empty set of data source descriptors.

4. The select method of the binding module 118 may throw an exception.

5. The select method of the binding module 118 may return an out-of-range array index.

6. The port manager 128 may respond with an error indication rather than with an access port 524.

In any of these situations, no subscription is made to notifications of new advertisements, and the binding expression is bound to an error source. The error source is a source that returns a special error value whenever it is asked for its current value.

The foregoing description of the invention has been presented for purposes of illustration and description. Thus, the above description is not intended to be exhaustive or to limit the invention to the precise form disclosed, and other modifications and variations may be possible. The embodiments disclosed were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

1. A system for rebinding a binding expression to a new network resource, wherein a data specification describes a resource required by the binding expression, the system comprising:
a data resolution service configured to discover network resources that satisfy the data specification; and
means for rebinding the binding expression to the new network resource when the data specification changes.

2. The system of claim 1, wherein the data specification is computed at least partially from previously received data.

3. The system of claim 1, wherein the means for rebinding receives announcements of changes in a currently bound network resource.

4. The system of claim 3, wherein the data resolution service communicates the announcements to the means for rebinding.

5. The system of claim 1, wherein the means for rebinding initiates rebinding according to programmer-specified criteria in response to the announcements.

6. A system for rebinding a binding expression to a new network resource, wherein a data specification describes a resource required by the binding expression and a resource descriptor describes a currently bound network resource, the system comprising:
a data resolution service configured to discover network resources that satisfy the data specification; and
means for rebinding the binding expression to the new network resource when the resource descriptor changes.

7. The system of claim 6, wherein the means for rebinding receives announcements of changes in the currently bound network resource from the data resolution service.

8. The system of claim 7, wherein the means for rebinding initiates rebinding according to programmer-specified criteria in response to the announcements.

9. A method for rebinding a binding expression to an appropriate network resource in a network, the binding expression being associated with a data specification describing the data required at the binding expression, the network including a current network resource, and the network resources including at least one resource property, the method comprising:
obtaining a list indicating potential appropriate network resources;
selecting an appropriate network resource from the list; and rebinding the binding expression to the appropriate network resource.

10. The method of claim 9, further comprising receiving an announcement of a change in the current network resource.

11. The method of claim 10, further comprising requesting the list upon receipt of the announcement.

12. The method of claim 9, further comprising determining whether the current network resource is no longer appropriate.

13. The method of claim 9, further comprising evaluating the data specification upon a request for a current value of the binding expression.

14. The method of claim 9, further comprising requesting the list upon a change in the value of the data specification.

15. The method of claim 9, further comprising obtaining an access port for the appropriate network resource.

16. The method of claim 9, further comprising if an error occurs, rebinding the binding expression to an error source.

17. The method of claim 9, wherein selecting the appropriate network resource further comprises determining the appropriate network resource according to programmer-specified criteria.

18. A system for rebinding a binding expression to an appropriate network resource in a network, the binding expression being associated with a data specification describing the data required at the binding expression, the network including a current network resource, and the network resources including at least one resource property, the system comprising:
a data resolution service configured to provide a list indicating potential appropriate network resources; and
a port manager configured to provide an access port to the appropriate network resource such that the binding expression rebinds to the appropriate network resource via the access port.

19. The system of claim 18, further comprising a binding module configured to select the appropriate network resource from the list indicating potential appropriate network resources.

20. The system of claim 19, wherein the data resolution service sends an announcement to the binding module when a change in the resource property of the current network resource occurs.

21. A computer program product embodied in a tangible media comprising:
computer readable program codes coupled to the tangible media for rebinding a binding expression to an appropriate network resource in a network, the binding expression being associated with a data specification describing the data required at the binding expression, the network including a current network resource, and the network resources including at least one resource property, the computer readable program codes comprising:
first computer readable program code configured to cause the program to provide a list indicating potential appropriate network resources;
second computer readable program code configured to cause the program to select an appropriate network resource from the list; and
third computer readable program code configured to cause the program to rebind the binding expression to the appropriate network resource.

22. The computer program product of claim 21, wherein the tangible media comprises a magnetic disk.

23. The computer program product of claim 21, wherein the tangible media comprises an optical disk.

24. The computer program product of claim 21, wherein the tangible media comprises a propagating signal.

25. The computer program product of claim 21, wherein the tangible media comprises a random access memory device.
